(19) United States
(12) Patent Application Publication
(10) Pub. No.: US 2007/0169631 A1
(43) Pub. Date: Jul. 26, 2007

(54) Interpolation filter of press coffee pot

(75) Inventor: Zhengdong Lian, Nanjing (CN)

Correspondence Address: HAMRE, SCHUMANN, MUELLER & LARSON, P.C., P.O. BOX 2902, MINNEAPOLIS, MN, 55402-0902, US

(73) Assignee: Sohome Houseware (Nanjing) Co., Ltd.

(21) Appl. No.: 11/398,924

(22) Filed: Apr. 6, 2006

(30) Foreign Application Priority Data
Jan. 20, 2006 (CN) 200620000791.9

(51) Int. Cl. A47J 31/00

(52) U.S. Cl. 99/279

(57) ABSTRACT

It is an interpolation filter for press coffee pots. It is formed as two upper and lower clips made of nontoxic plastic clamping in-between a holed sheet metal hold by a rubber ring. With the present invention, it is convenient to install and remove the filter and the filter will not slipping and scratch inner wall of the container.

### BACKGROUND OF THE INVENTION

This present invention involves a coffee pot filter, especially the interpolation filter for press coffee pots.

### DESCRIPTION OF THE RELATED ART

When using the press coffee pot to brew coffee, you need to separate coffee grounds from coffee to make a purely tasted and caffeine-free coffee. To achieve that, you need to place the interpolation filter in the press coffee pot. The current interpolation filter (hereafter referred as filter for short) adopts a metal sheet as the filter screen and is of a dish-shaped structure formed by folding upward the metal brim made like fan leaves. When you place the filter in the glass container, fan leaves at the brim will join with the inner glass wall according to tolerance changes of the container and fix at the desired place. When hot water is poured into the glass container, due to the different expansion coefficients of glass and metal, the filter will slip towards bottom of the pot. Besides that, when you try to get out the filter after use, due to the friction between metal fan leaves and the inner glass wall, metal fan leaves are likely to scratch the inner glass wall and the filter will be difficult to be removed from the pot, greatly affecting the utility.

### SUMMARY OF THE INVENTION

The present invention involves solving the technical problem of providing an interpolation filter for press coffee pots easy to install and remove and not susceptible to slipping and scratching inner wall of the container.

To solve the above technical problem, this present invention adopts the following technical solution: A type of interpolation filter for press coffee pots, which is formed as two upper and lower clips made of nontoxic plastic clamping in-between a holed sheet metal hold by a rubber ring.

Clips made of nontoxic plastics are formed by at least two supporting scroll structures radiating from the central axis to the rim. Areas between the central axis, supporting scroll and rim are hollowed out.

Mesh holes of a round shape are set at the free area of the clips made of nontoxic plastics clamping in-between the metal sheet.

The rubber ring is of a hollow ring structured as hollow rims with the inner rim and outer rim designed as of a ring-shaped bulging structure.

A circular groove is set at the bulging area of the inner rim of the rubber ring corresponding to the inner side of the outer brim of the rim of the clips made of nontoxic plastics.

The holed metal sheet is made of stainless steel.

The rubber ring is a silastic ring.

Installing and removing the filter with the present invention are convenient and the filter will not slip and scratch inner wall of the container.

### BRIEF DESCRIPTION OF THE DRAWINGS

FIG. 1 is the elevation of the upper tablet of the present invention;

FIG. 2 is the bottom view of the upper tablet of the present inventio;n

FIG. 3 is the elevation of the lower tablet of the present invention;

FIG. 4 is the bottom view of the lower tablet of the present invention;

FIG. 5 is the bottom view of the upper tablet of the present invention ;

FIG. 6 is the structure of the holed metal sheet of the present invention;

FIG. 7 is the section view of the silastic ring of the present invention;

FIG. 8 is the structure of the upper surface of the present invention;

FIG. 9 is the structure of the lower surface of the present invention.

### DETAILED DESCRIPTION OF THE PREFERRED EMBODIMENTS

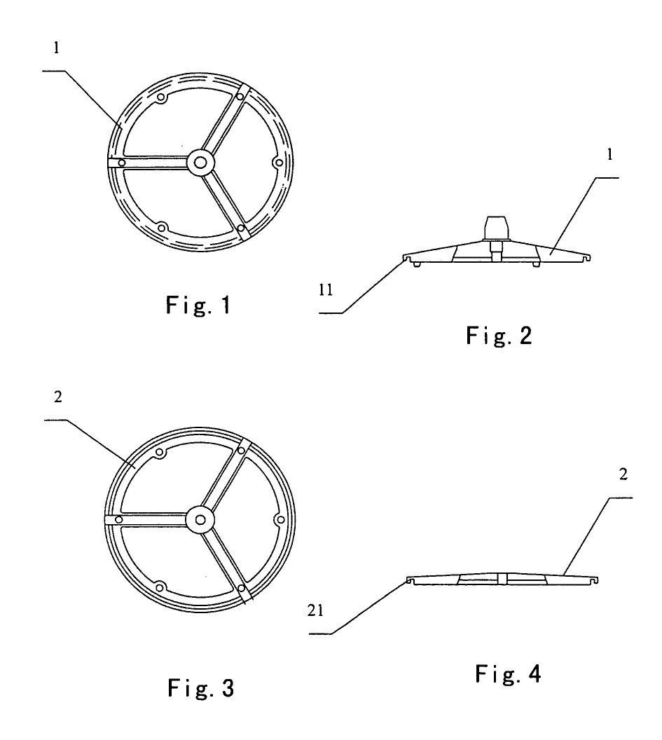

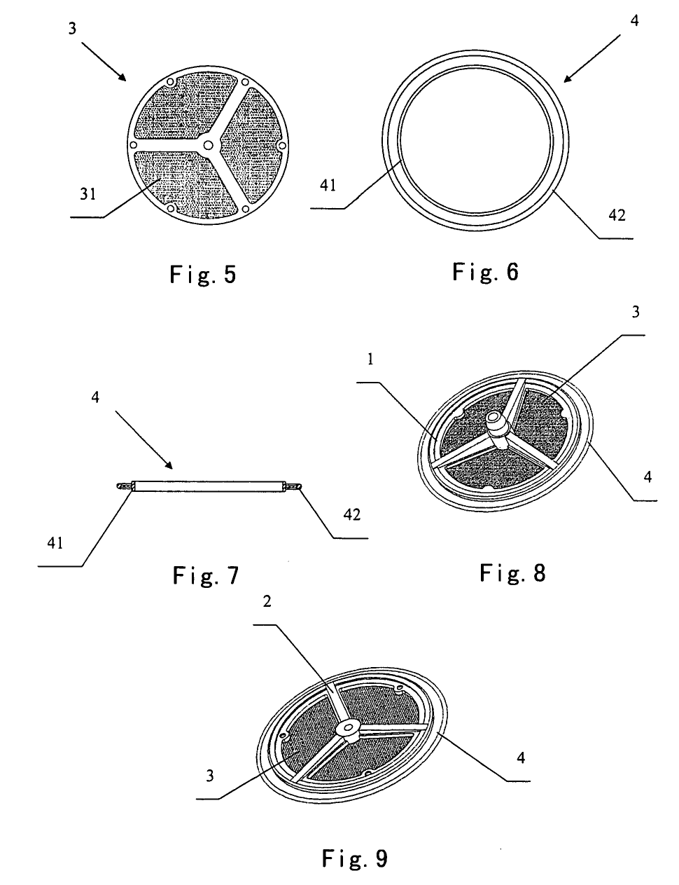

As illustrated in FIG. 1 to FIG. 7, it is an interpolation filter for press pots. It is formed; as the upper clip 1 and lower clip 2 clamping a holed and stainless steel sheet 3 in-between fixed in place by silastic ring 4.

Clip 1 and clip 2 made of non-toxic plastics radiate from the central axis three supporting scrolls to the rim. Areas between the three supporting scrolls and the rim are hollowed out to form a structure similar to a car steer. Inner and outer diameters of the rim of upper clip 1 and lower clip 2 made of nontoxic plastics are equal.

The free area on the holed stainless steel sheet 3 corresponding to the upper clip 1 and lower clip 2 made of nontoxic plastics is treated with corrosion technologies to make regular holes. The holed stainless sheet 3 is of a round shape and its diameter is greater than the inner diameter of the rim of upper clip 1 and lower clip 2 made of non-toxic plastics and smaller than the outer diameter of the rim of upper clip 1 and lower clip 2 made of non-toxic plastics. The silastic ring 4 is structured as two hollow rims with the outer rim 41 and inner rim 42 designed as of a ring-shaped bulging structure.

The circular groove 11 is set at the bulging area of the inner rim 41 of the silastic ring corresponding to the inner side of the outer brim of the rim of the clip 1 made of nontoxic plastics. The circular groove 21 is set at the bulging area of the inner rim 41 of the silastic ring corresponding to the inner side of the outer brim of the rim of the clip 2 made of nontoxic plastics.

As illustrated in FIG. 8 to FIG. 9, stack the upper clip 1 made of nontoxic plastics, holed stainless steel sheet 3, silastic ring 4 and lower clip 2 made of nontoxic plastics in order, and then weld them together using ultrasonic welding techniques. In that way to clamp tight the holed stainless steel sheet 3 and silastic ring 4 to form a single entity. When using, place the interpolation filter for pressed coffee pots into the coffee pot. The silastic ring of the filter can shrink and release conveniently according to tolerance of the inner diameter of the coffee pot to adjust to the proper place.

1. An interpolation filter for the press type of coffee pots, comprising: both upper and lower clip sheets made of nontoxic plastics and a sandwiched perforated metal sheet hold by a rubber ring.

2. The interpolation filter of claim 1, wherein said clip sheets made of nontoxic plastics have the structure at least two supporting spokes radiating from the central axis to the rim, and the areas between the central axis, supporting spokes and rim are hollowed out.

3. The interpolation filter of claim 1, wherein the mesh-like orifices of round shape are arranged at the areas of the above said perforated metal sheets which correspond the void regions of the clip sheets made of nontoxic plastics.

4. The interpolation filter of claim 1, wherein said rubber ring has structure of a hollow rim with the inner rim and outer rim having a ring-shaped bulging structure.

5. The interpolation filter of claim 1, wherein a the annular grooves are arranged at the inner sides of the outer edges of the rims of said clip sheets made of nontoxic plastics which correspond the bulging area of the inner rim of the rubber ring.

6. The interpolation filter of claim 1, wherein a silastic ring is used as said rubber ring.
